(19) United States
(12) Patent Application Publication
(10) Pub. No.: US 2017/0255921 A1
(43) Pub. Date: Sep. 7, 2017

(54) Mobile Vending Machine

(71) Applicant: ChengDu HaiCun IP Technology LLC, ChengDu (CN)

(72) Inventor: Guobiao ZHANG, Corvallis, OR (US)

(73) Assignee: ChengDu HaiCun IP Technology LLC, ChengDu (CN)

(21) Appl. No.: 15/447,048

(22) Filed: Mar. 1, 2017

(30) Foreign Application Priority Data
Mar. 2, 2016 (CN) 201610116393.1
Feb. 28, 2017 (CN) 201710110700.X

(51) Int. Cl. G06Q 20/32; G06Q 30/06; G06Q 20/18

(52) U.S. Cl. CPC G06Q 20/327; G06Q 20/18; G06Q 30/0645

(57) ABSTRACT

The present invention discloses a mobile vending machine and the associated card-rental method for long-distance travels. The mobile vending machine contains a large number of content cards (e.g. TF cards). A user may rent a content card from the mobile vending machine. To facilitate playback in all types of mobile devices, the present invention further discloses several preferred multi-slot content/power pack and a preferred multi-slot mobile device.

### BACKGROUND

1. Technical Field of the Invention

The present invention relates to the field of vending machine, and more particularly to a vending machine for distributing multimedia contents to long-distance travelers.

2. Prior Art

A DVD-rental machine (e.g. Redbox vending kiosk) has tremendous cost advantages over the traditional brick-and-mortar DVD-rental store, as they require much less space and fewer staff. U.S. Pat. No. 7,234,609, issued to DeLazzer et al. on Jun. 26, 2007, U.S. Pat. No. 8,538,581 issued to Kuehnrich et al. on Sep. 17, 2013, and U.S. Pat. No. 9,196,005 B2 issued to Williams et al. on Nov. 24, 2015 disclose a DVD-rental machine 20 and an associated DVD-rental method. As illustrated in FIG. 1, the DVD-rental machine 20 is located in a grocery store (or, a fast food restaurant, a gas station) 80 to distribute video discs (e.g. DVDs, including music, video games and other dispensable articles). A panel 24 displays the titles of the video collections and a user 10 uses a keypad 22 to make selections.

The DVD-rental method is more suitable for home/office users than mobile users. Because DVDs are relatively large, a DVD-rental machine 80 carrying a large DVD inventory occupies a large physical space and cannot fit in a long-distance travel environment (e.g. a car, a bus, a train, or a plane). Furthermore, because a DVD has limited capacity, a user needs to rent a large number of DVDs for long-distance travels. Lastly, because the DVDs are read only, the DVD inventory of the DVD-rental machine 80 needs to be replenished on a regular basis. This costs a lot of manpower.

As mobile devices (e.g. cell phones, tablet devices) become ubiquitous, a content-download method becomes more suitable for mobile users. For the content-download method, the desired contents are downloaded to a mobile device wirelessly. Common content-download methods include cellular download, WiFi download and pre-fetch. In general, the content-download method is more suitable for city excursions than long-distance travels. This is because of the following reasons: 1) although cellular signal can be used to download contents, it is difficult to provide high-speed full cellular coverage for the geographic areas covered by long-distance travels; 2) although content servers and public WiFi hotspots can be installed in long-distance transportation (e.g. a bus, a train, or a plane), they are very expensive considering a large number of units that need to be installed; 3) pre-fetch requires a user to download the contents at home/office beforehand. This method is fine with short excursions, but not convenient for long-distance travels.

### OBJECTS AND ADVANTAGES

It is a principle object of the present invention to provide a vending machine which distributes multimedia contents to long-distance travelers.

It is a further object of the present invention to provide a vending machine which dispenses media whose contents can be remotely updated.

It is a further object of the present invention to provide a multi-slot content/power pack supporting both mobile vending machines and mobile devices.

It is a further object of the present invention to provide a multi-slot mobile device supporting mobile vending machines.

In accordance with these and other objects of the present invention, the present invention discloses a mobile vending machine and the associated card-rental method.

### SUMMARY OF THE INVENTION

The present invention discloses a preferred mobile vending machine and the associated card-rental method. The mobile vending machine is installed in a long-distance travel environment, including a long-distance transportation (e.g. a train, a bus, or a plane) and/or its associated station (e.g. a train station, a bus stop, or an airport). It contains a large number of content cards (e.g. TF cards) which store pre-recorded contents (e.g. movies, videos, TV programs, music, games, electronic books, audio books, etc.). A user (e.g. a long-distance traveler) may rent at least one desired content card from the mobile vending machine using a mobile device (e.g. a cell phone, a tablet device). The user may further playback the rented content card on the mobile device. To facilitate playback in all types of mobile devices, the present invention further discloses several preferred multi-slot content/power pack and a preferred multi-slot mobile device.

For long-distance travels, the card-rental method offers several advantages over the traditional DVD-rental method as well as the mainstream content-download method. First of all, let's compare the card-rental method to the DVD-rental method. Because content cards have a much smaller physical dimension than DVDs (the dimension of a TF card is 15 mm×11 mm×1 mm, whereas a DVD is 120 mm in diameter and 1.5 mm in thickness), a mobile vending machine containing hundreds of content cards (which could be as small as a thick magazine or slightly larger) is much smaller than a DVD-rental machine. It can be easily installed in a long-distance travel environment. Moreover, since content cards have a much larger storage capacity than DVDs (a TF card can store 100+ movies, whereas a DVD can store only a single movie), content cards provide much more selections for long-distance travelers. More importantly, unlike DVDs which are read-only, the content cards are electrically re-writable and their contents can be automatically updated by the mobile vending machine. Because the card inventory in the mobile vending machine does not need to be physically replenished on a regular basis, this greatly saves manpower and lowers the maintenance cost.

Secondly, let's compare the card-rental method to the content-download method. During long-distance travels, high-speed and high-quality cellular connections are too scarce to provide a pleasant movie-watching experience. The card-rental method provides a user with a better experience because the rented content cards contain pre- recorded contents. In addition, because a user can walk a distance to rent cards, a mobile vending machine can serve a much larger geographic area than a public WiFi hotspot. Take a train as an example: for the card-rental method, a train (e.g. including around ten cars) needs just one or two vending machines; for the content-download method, this train would need tens of WiFi hotspots. Overall, the card-rental method offers better experience but costs less than the content-download method for long-distance travels.

### BRIEF DESCRIPTION OF THE DRAWINGS

FIG. 1 illustrates a prior-art DVD-rental machine (e.g. a Redbox vending kiosk);

FIG. 2 illustrates a preferred card-rental method associated with a preferred mobile vending machine;

FIG. 3A is a perspective view of a preferred mobile vending machine; FIG. 3B is its cross-sectional view; FIG. 3C is its block diagram;

FIG. 4 discloses a preferred method to obtain a content card from the preferred mobile vending machine;

FIG. 5 discloses a preferred method to play a selected content by the mobile device;

FIG. 6 discloses a preferred method to return a content card to the preferred mobile vending machine;

FIG. 7 discloses a preferred method to remotely update the contents in the content cards through the preferred mobile vending machine;

FIG. 8A is a perspective view of a first preferred agent-assisted mobile vending machine; FIG. 8B is its cross-sectional view along the cutline B-B′; FIG. 8C is its block diagram;

FIG. 9A is a perspective view of a second preferred agent-assisted mobile vending machine; FIG. 9B is its cross-sectional view along the cutline C-C′; FIG. 9C is its block diagram;

FIG. 10A discloses a preferred multi-slot content/power pack supporting both mobile vending machines and mobile devices; FIG. 10B shows its front panel; FIG. 10C shows its back panel; FIG. 10D is the block diagram of a first preferred multi-slot content/power pack; FIG. 10E is the block diagram of a second preferred multi-slot content/power pack;

FIG. 11 discloses a preferred multi-slot mobile device supporting mobile vending machines.

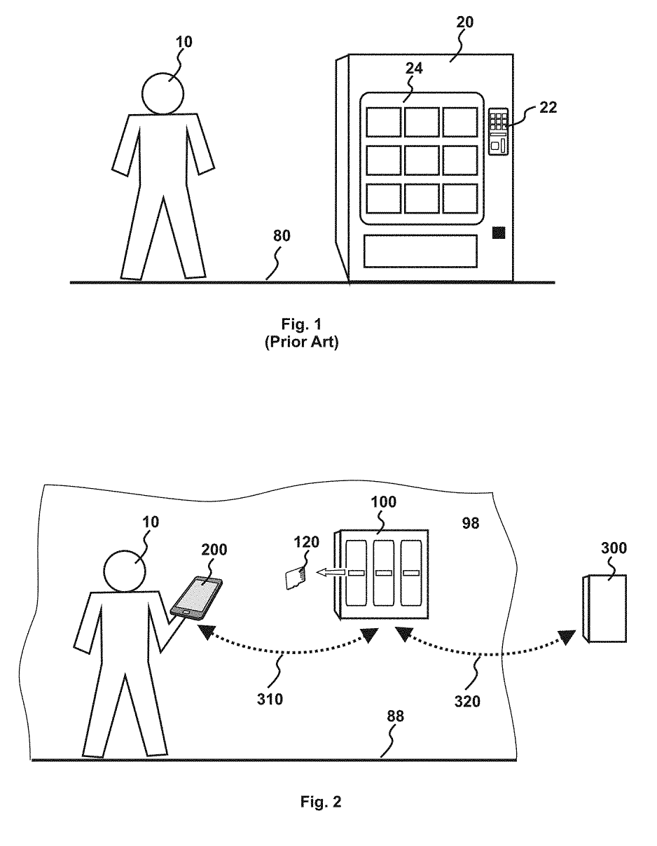

It should be noted that all the drawings are schematic and not drawn to scale. Relative dimensions and proportions of parts of the device structures in the figures have been shown exaggerated or reduced in size for the sake of clarity and convenience in the drawings. The same reference symbols are generally used to refer to corresponding or similar features in the different embodiments.

### DETAILED DESCRIPTION OF THE PREFERRED EMBODIMENTS

Those of ordinary skills in the art will realize that the following description of the present invention is illustrative only and is not intended to be in any way limiting. Other embodiments of the invention will readily suggest themselves to such skilled persons from an examination of the within disclosure.

Referring now to FIG. 2, a preferred card-rental method associated with a preferred mobile vending machine is disclosed. This preferred mobile vending machine 100 is mounted on a wall 98, which is a part of a long-distance travel environment 88. The long-distance travel environment 88 includes a long-distance transportation (e.g. a train, a bus, or a plane) and/or its associated station (e.g. a train station, a bus stop, or an airport).

The preferred mobile vending machine 100 contains a plurality of pre-recorded content cards for rent. These content cards can be categorized into at least one card-group, with each card-group storing at least one type of contents. For example, type-A card-group stores classical movies, type-B card-group stores dramas, and type-C card-group stores comedies, etc. The content cards in a mobile vending machine 100 may belong to multiple card-groups. Alternatively, the content cards in a mobile vending machine 100 may belong to a single card-group while multiple mobile vending machines 100 are installed in the long-distance travel environment 88.

After a user 10 carrying a mobile device (e.g. a cell phone, a tablet device) 200 approaches the mobile vending machine 100, a first connection 310 is established between the mobile vending machine 100 and the mobile device 200, through which the user 10 obtains the authorization to receive a content card 120. After the mobile vending machine 100 dispenses this content card 120 from the dispensing slot 110A, the user 10 inserts the content card 120 into the mobile device 200 and selects the desired content to play back. Besides the first connection 310, the mobile vending machine 100 periodically retrieves updated contents from a remote server 300 through a second connection 320.

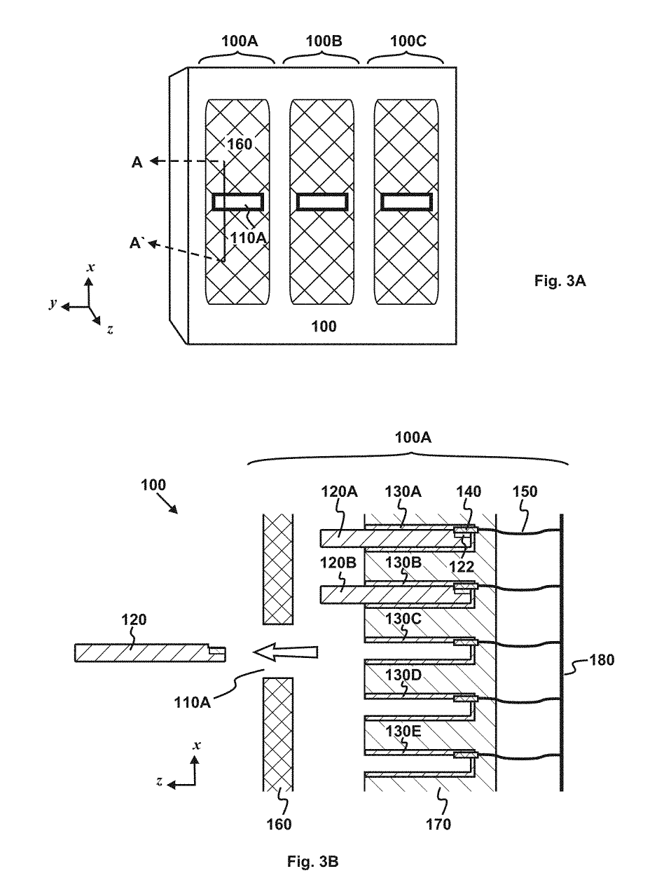

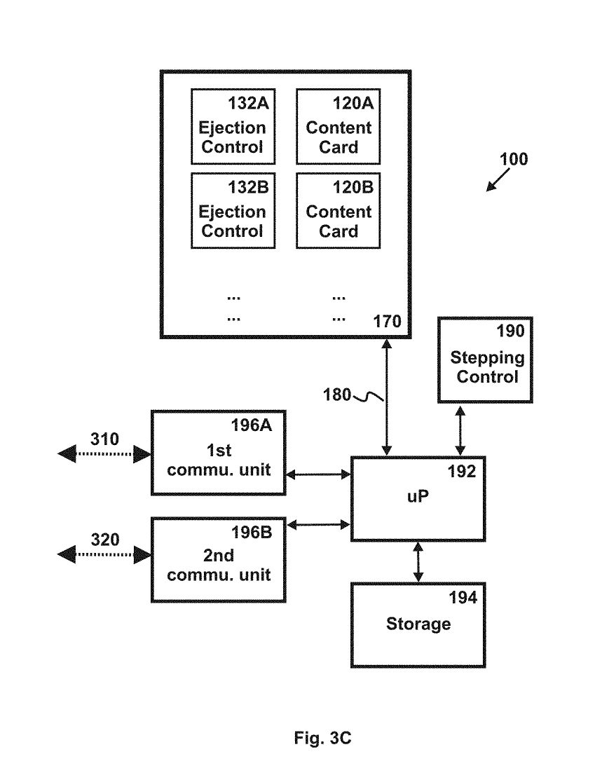

Referring now to FIGS. 3A-3C, a first preferred mobile vending machine 100 is disclosed. The preferred mobile vending machine 100 is an automatic vending machine. As is shown in FIG. 3A, this preferred embodiment has three dispensing units 100A-100C, with each dispending unit containing one card-group. For example, the dispensing unit 100A contains type-A card-group, the dispensing unit 100B contains type-B card-group, and the dispensing unit 100C contains type-C card-group. Apparently, the mobile vending machine 100 may have more than three dispensing units. The front panel 160 of each dispensing unit 100A comprises a dispensing slot 100A, through which the content card is dispensed or returned. The front panel 160 may further comprise a display screen or a printed material to show the content table of the associated card-group.

FIG. 3B is the cross-sectional view of the preferred mobile vending machine 10 along the cut-line AA′. Each dispensing unit 100A comprises a body 170, a cover 160, and a system bus 180. The body 170 comprises a plurality of receptacles 130A, 130B . . . . Each receptacle 130A further comprises an ejection control, a receptacle contact 140 mating to the card contact 122, a wire 150 coupling the receptacle contact 140 to the system bus 180. In the body 170, the receptacles 130A, 130B hold the pre-recorded content cards 120A, 120B; the receptacle 130C is aligned with the dispensing slot 110A and a content card 120 is just being ejected; the receptacles 130D, 130E are empty.

To dispense a content card 120 from the body 170, the body 170 and the cover 160 make a relative motion in such a way that a dispensing slot 110A is aligned with an occupied receptacle 130C. The ejection control is turned on to dispense the content card 120 from the occupied receptacle 130C through the dispensing slot 110A. To insert a content card 120 to the body 170, the body 170 and the cover 160 make a relative motion in such a way that a dispensing slot 110A is aligned with an empty receptacle 130C. The content card 120 can then be inserted into the empty receptacle 130C through the dispensing slot 110A.

FIG. 3C is a block diagram of the preferred mobile vending machine 100. It comprises a processor 192, a local storage 194, a body 170, first and second communication units 196A, 196B and a stepping control 190. The local storage 194 stores the updated contents downloaded from a remote server 300. It could be a mechanical hard-disk drive (HDD) or a solid-state drive (SSD). The first communication unit 196A couples the mobile vending machine 100 to the mobile device 200. It could be a short-range or medium-range wireless communication means (e.g. Bluetooth or WiFi). The second communication unit 196B couples the mobile vending machine 100 to the remote server 300. It could be a long-range wired communication means (e.g. LAN) or a medium-range wireless communication means (e.g. WiFi). The processor 192 is a CPU or MCU, which processes information received from the storage 194, communication units 196A, 196B and sends commands/data to the body 170 and the stepping control 190 through the system bus 180.

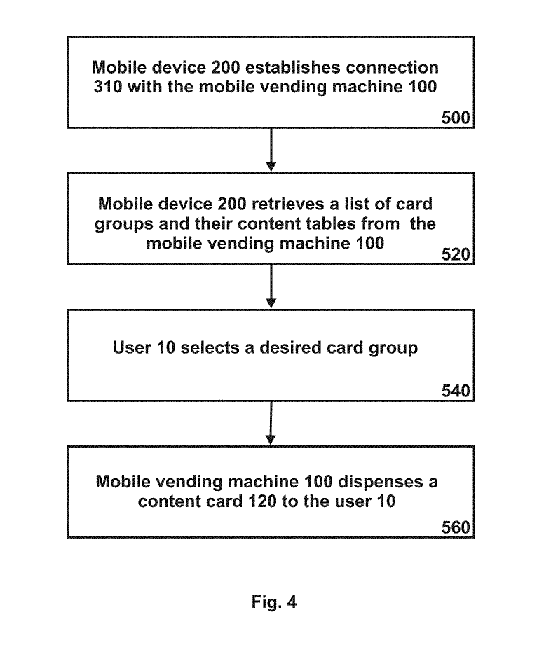

FIG. 4 discloses a preferred method to obtain a pre-recorded content card 120 from the preferred mobile vending machine 100. It includes the following steps. First, the mobile device 200 establishes a first connection 310 with the vending machine 100 (step 500). Through the first connection 310, the mobile device 200 retrieves a list of card-groups and their content tables from the mobile vending machine 100 (step 520). After viewing the content table of each card-group on the mobile device 200, the user 10 selects a desired card-group (step 540). Then the mobile device 200 obtains authorization for the selected card-group by making a deposit or using a credential linked with the mobile device 200. Finally, the mobile vending machine 100 dispenses a pre-recorded content card 120 from the selected card-group to the user 10 (step 560).

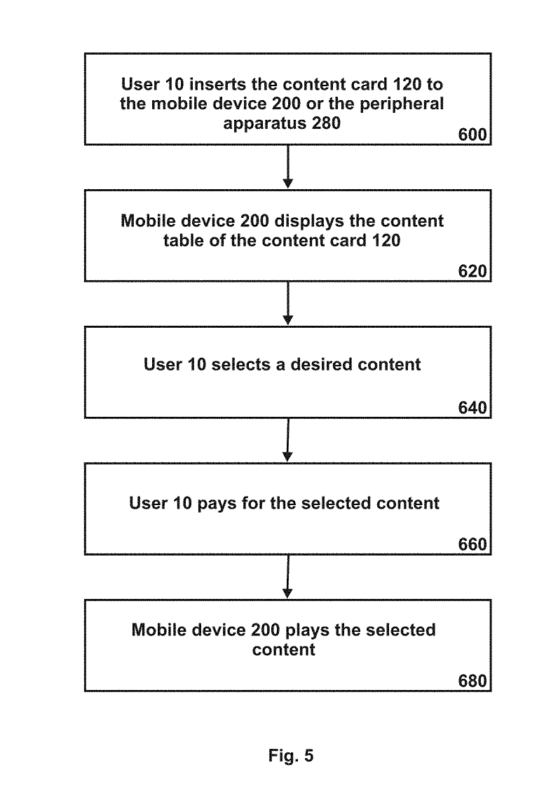

FIG. 5 discloses a preferred method to play a desired content by the mobile device 200. It includes the following steps. First, the user 10 inserts a content card 120 to the mobile device 200 (step 600). If the playback app has not yet been installed in the mobile device 200, the mobile device 200 retrieves the playback app from the content card 120 (the playback app can be pre-recorded in the content card 120) to install it in the mobile device 200. The playback app then displays the content table of the content card 120 (step 620). From the content table, the user 10 selects a desired content (step 640). The user pays the usage fee for the selected content on a pay-per-view or a pay-by-time basis (step 660). For pay-per-view, the mobile device 200 obtains authorization to view the selected content by paying the fee associated therewith. Afterwards, the mobile device 200 plays the selected content (step 680). For pay-by-time, the usage fee of the content card 120 is charged by the hours for which the content card 120 is accessed by the mobile device 200.

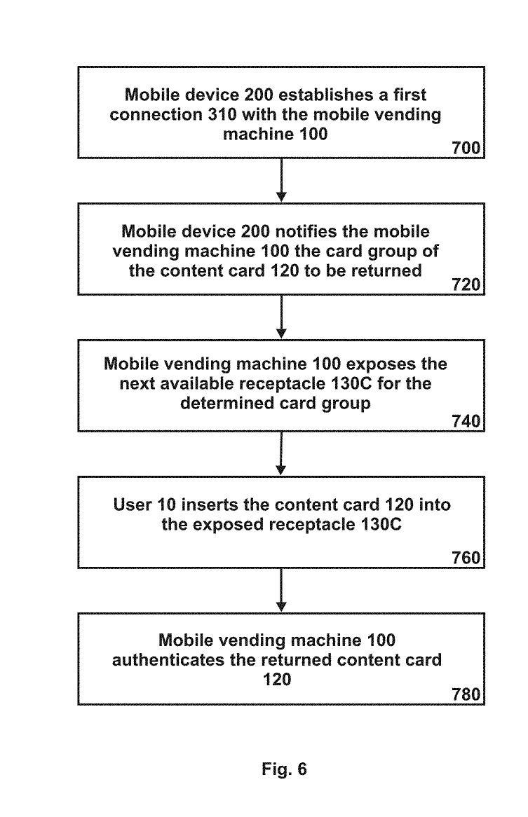

FIG. 6 discloses a preferred method to return a content card 120 to the preferred mobile vending machine 100. It includes the following steps. First, the mobile device 200 establishes a first connection 310 with the mobile vending machine 100 (step 700). Through the first connection 310, the mobile device 200 notifies the mobile vending machine 100 the card-group of the content card 120 to be returned (step 720). Then the mobile vending machine 100 exposes the next available receptacle 130C for the determined card-group (step 740), through which the user 10 inserts the content card 120 (step 760). Finally, the mobile vending machine 100 authenticates the returned content card 120 (step 780). The authentication generally involves the steps of checking the data integrity of pre-defined locations in the content card 120. Once the returned content card 120 is authenticated, the deposit is returned to the user 10.

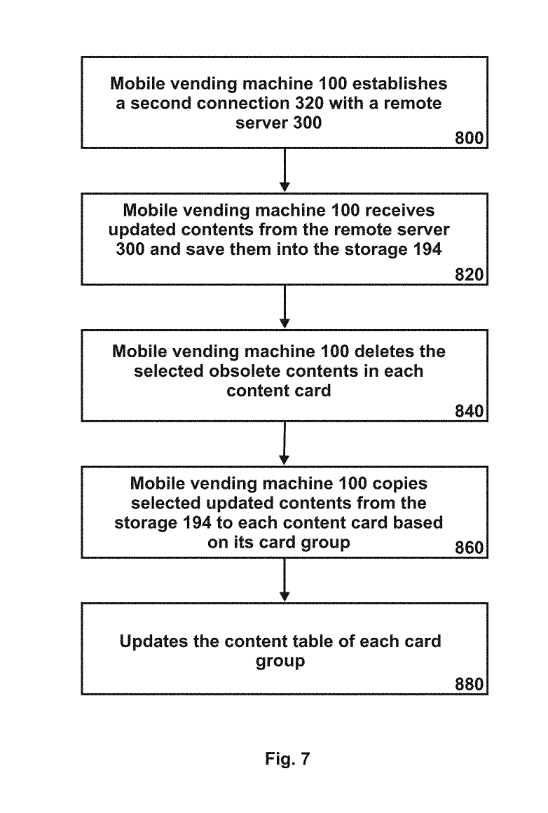

FIG. 7 discloses a preferred method to remotely update the contents of the content card 120 by the preferred mobile vending machine 100. It includes the following steps. First, the mobile vending machine 100 establishes a second connection 320 with the remote server 300 (step 800). Through the second connection 320, the mobile vending machine 100 receives updated contents from the remote server 300 and stores them in the local storage 194 (step 820). Optionally, the mobile vending machine 100 deletes selected obsolete contents in the content card 120 (step 840). Afterwards, the mobile vending machine 100 copies the updated contents selected from the local storage 194 to each content card based on its card-group (step 860). Lastly, the mobile vending machine 100 updates the content table of each card-group (step 880).

The preferred mobile vending machine 100 disclosed in FIGS. 3A-7 is an automatic vending machine, which does not require any human intervention. Besides automatic vending machine, the present invention further discloses two preferred semi-automatic vending machine. These semi-automatic vending machines are agent-assisted mobile vending machines, which are carried around by a rental agent in a mobile environment and whose transactions are assisted by the rental agent. A mobile user directly rents a content card from the rental agent. As an example, the mobile user uses his/her mobile device to scan a barcode on the vending machine to establish a connection (e.g. Bluetooth, WiFi). After selecting the desired card-group, the mobile user pays the deposit and receives the desired content card. Upon return, the rental agent inserts the returned content card to the appropriate slot. The agent-assisted vending machine has two major functions: one is to automatically update contents in the content cards, the other is to authenticate the returned content cards.

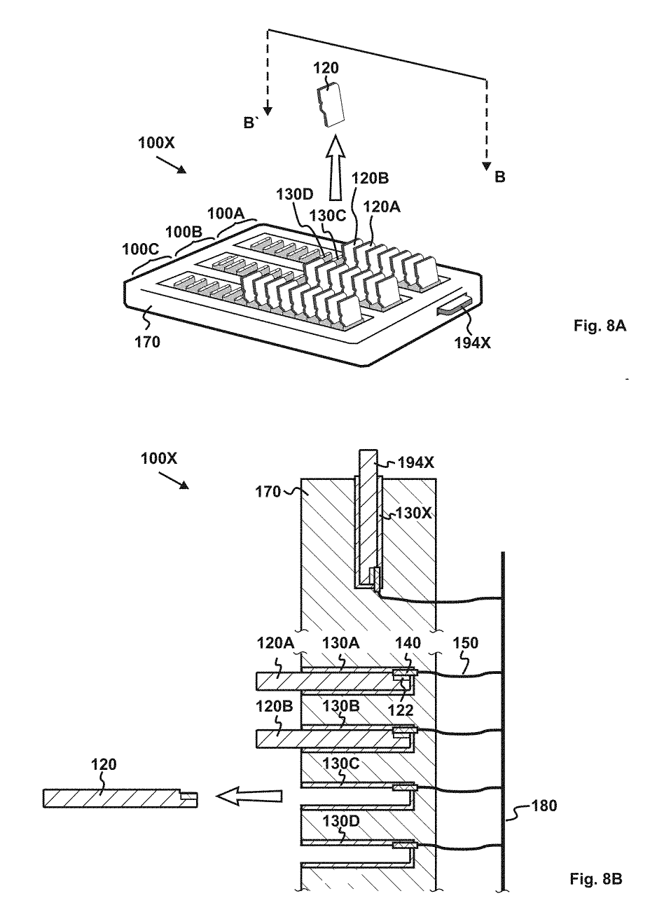

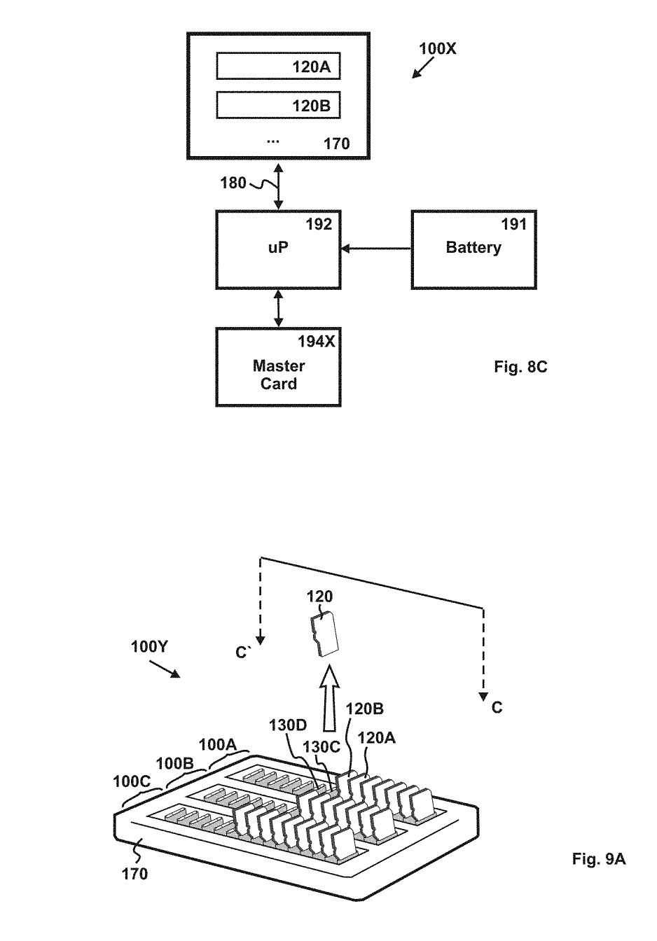

Referring now to FIGS. 8A-8C, a first preferred agent-assisted mobile vending machine 100X is disclosed. It is a hand-held device powered by a battery 191. The vending machine 100X is a simplified version of the mobile vending machine 100 and has three dispensing units 100A-100C, with each dispending unit containing one card-group (FIG. 8A). For example, the dispensing unit 100A contains type-A card-group, the dispensing unit 100B contains type-B card-group, and the dispensing unit 100C contains type-C card-group. The body 170 of the mobile vending machine 100X comprises a plurality of receptacles 130A-130D (FIG. 8B). In this preferred embodiment, the receptacles 130A, 130B hold the content cards 120A, 120B, while the receptacles 130C, 130D are empty with the content card 120 in the receptacle 130C just being ejected. This preferred agent-assisted mobile vending machine 100X further comprises a master receptacle 130X, which holds a master content card 194X. The master content card 194X stores updated contents and is regularly replaced by a service person. Once the master content card 194X is placed into the master receptacle 130X, the updated contents are copied from the master content card 194X to the content cards 120A, 120B . . . through the system bus 180 under the control of processor 192 (FIG. 8C). It should be apparent to those skilled in the art that the master receptacle and master content card can also be used in the preferred embodiment of FIGS. 3A-3C as a source of the updated contents. In this case, the second communication unit 196B is not needed to obtain updated contents.

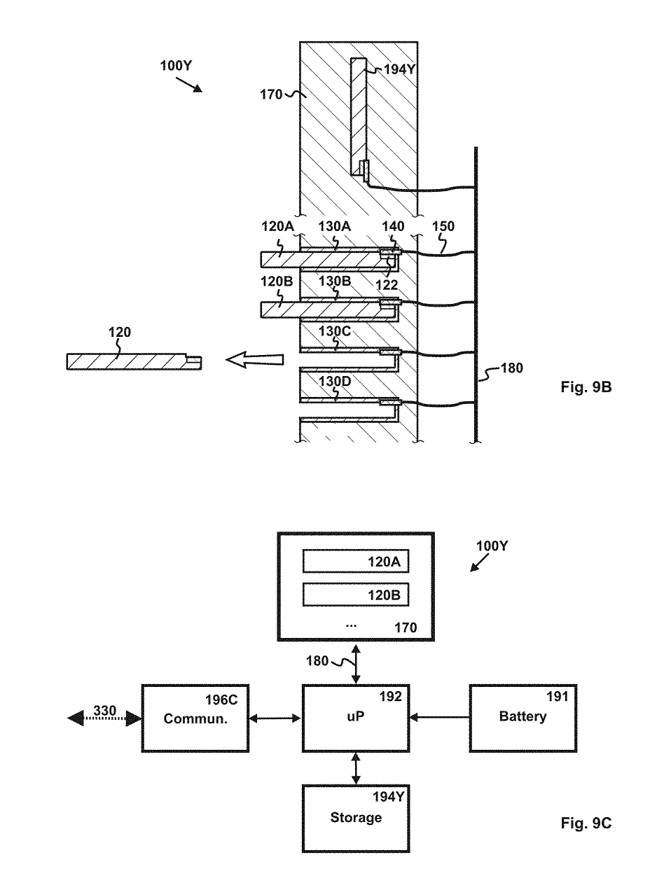

Referring now to FIGS. 9A-9C, a second preferred agent-assisted mobile vending machine 100Y is disclosed. The difference between 100X and 100Y is that the vending machine 100X uses a master content card to update contents, whereas the vending machine 100Y uses a wireless download means to update contents. FIGS. 9A-9C are similar to FIGS. 8A-8C, except that the body 170 of the vending machine 100Y does not comprise a master receptacle 130X for the master content card 194X (FIGS. 9A-9B). The updated contents are stored in a local storage 194Y, which is embedded in the vending machine 100Y (FIG. 9C). The vending machine 100Y further comprises a third communication unit 196C, through which it obtains the updated contents using a third connection 330.

The content cards rented from the vending machines 100, 100X, 100Y are TF cards (or SD cards). These cards have been widely used in mobile devices 200. However, some mobile devices no longer support expansion card slots, while other mobile devices are designed in such a way that their card slots are difficult to open (for example, require a special pin). To solve these problems, the present invention discloses a content/power pack 280 supporting both mobile vending machines and mobile devices. It comprises at least two expansion slots for the content cards and at least a portable battery. As such, this single peripheral apparatus 280 provides both contents and power to the mobile devices 200.

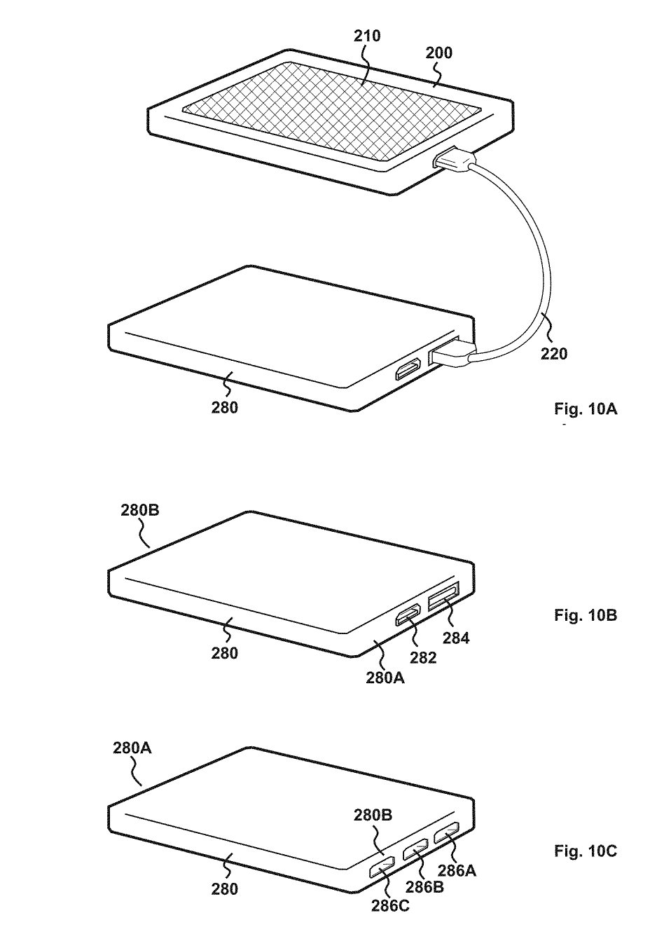

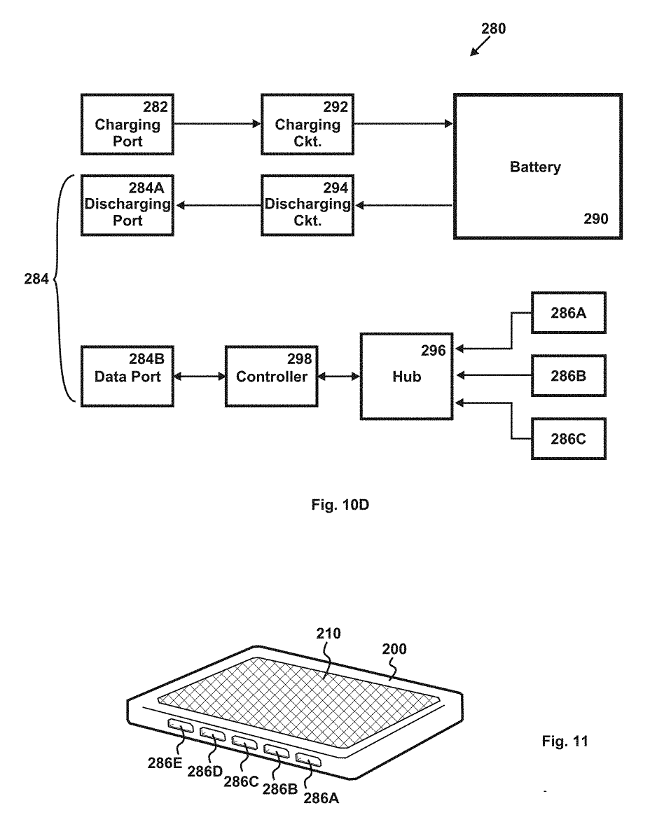

Referring now to FIGS. 10A-10E, a preferred multi-slot content/power pack 280 is disclosed. This peripheral apparatus 280 is an integrated portable battery and card reader. It is coupled to a mobile device 200 through a wire 220 (e.g. an USB bus) (FIG. 10A). Its front panel 280A comprises a charging port 282 and an output interface 284 (FIG. 10B). Its back panel 280B comprises at least three expansion slots 286A-286C (FIG. 10C). Each slot (e.g. 286A) can hold a content card (e.g. 120). The content/power pack 280 reads content from the content card in the slot (e.g. 286A), transfers the content to the mobile device 200, and plays it on the display 210. Apparently, the expansion slots can be located on back panel, side panel, or front panel.

FIG. 10D is a block diagram of a first preferred multi-slot content/power pack 280. It uses a wired means to transfer the content from the content card to the mobile device 200. It comprises a battery 290 which is charged by an external power source through a charging port 282 and a charging circuit 292. The battery 290 charges the mobile device 200 through a discharging port 284A and a discharging circuit 294. The expansion slots 286A-286C are coupled to a data port 284B through a hub 296 and a controller 298. The discharging port 284A and the data port 284B form the output interface 284.

FIG. 10E is a block diagram of a second preferred multi-slot content/power pack 280. It uses a wireless means to transfer the content from the content card to the mobile device 200. Its charging/discharging circuit is similar to that of FIG. 10D. Different from FIG. 10D, its expansion slots 286A-286C are coupled to the wireless communication unit 297 through the hub 296 and the controller 298. The wireless communication unit 297 comprises a wireless transceiver (e.g. Bluetooth or WiFi transceiver) and an antenna (e.g. Bluetooth or WiFi antenna). In the meantime, the battery 290 provides power to the expansion slots 286A-286C, hub 296, controller 298, and wireless communication unit 297. Because it is a short-range communication, the wireless communication unit 297 consumes little power.

In FIGS. 10A-10E, the multi-slot content/power pack 280 has at least three expansion slots. In contrast, a conventional mobile device has only a single expansion slot. This difference comes from the fact that they use different content-acquisition methods. The conventional mobile device uses the content-download method. Accordingly, one expansion slot is adequate. On the other hand, the present invention uses a card-rental method. During long-distance travels, since a traveler wants to access a large number of contents, he needs to rent a large number of content cards. If the content/power pack has a single expansion slot, the traveler has to change cards frequently during usage. Furthermore, being physically small, the content cards (e.g. TF cards) not held in the expansion slot are easy to get lost. With multiple expansion slots in the content/power pack, a user can access a large number of contents at once and the content cards are less likely to get lost.

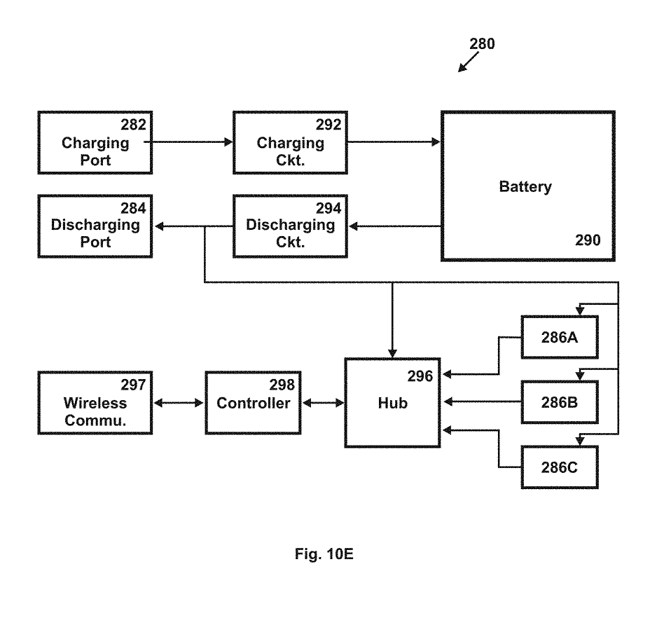

Referring now to FIG. 11, a preferred multi-slot mobile device 200 is disclosed. Similar to FIGS. 10A-10E, its side panel comprises five expansion slots 286A-286E. Other than that, this preferred mobile device 200 is similar to a conventional mobile device. The selected contents are played back on the display 210, while a battery provides power to the expansion slots 286A-286E and the display 210. Having multiple expansion slots in a mobile device 200 is to support the card-rental method: a long-distance traveler can access a large number of contents at once and the content cards are less likely to get lost.

While illustrative embodiments have been shown and described, it would be apparent to those skilled in the art that many more modifications than that have been mentioned above are possible without departing from the inventive concepts set forth therein. The invention, therefore, is not to be limited except in the spirit of the appended claims.

What is claimed is:

1. A mobile vending machine for distributing multimedia contents, comprising:
a body comprising a plurality of receptacles for holding a content card each, wherein said content card is electrically re-writable and stores at least a pre-recorded content;
a local storage for storing updated contents, wherein said local storage and said receptacles are electrically coupled;
wherein said updated contents are copied to said content card when said content card is in selected one of said receptacles.

2. The mobile vending machine according to claim 1, further comprising a communication unit for receiving said updated contents from a remote server.

3. The mobile vending machine according to claim 2, wherein said communication unit is a medium-range wireless communication unit or a long-range wired communication unit.

4. The mobile vending machine according to claim 1, further comprising:
at least a master receptacle for holding a master content card storing updated contents, wherein said master receptacle is electrically coupled to said plurality of receptacles;
wherein said master content card is said local storage; and, said updated contents are copied from said master content card to said plurality of content cards.

5. The mobile vending machine according to claim 1, further comprising another communication unit for communicating with a mobile device.

6. The mobile vending machine according to claim 6, wherein said another communication unit is a short-range or medium-range wireless communication interface.

7. The mobile vending machine according to claim 6, wherein said mobile device plays selected one of said content cards dispensed from said mobile vending machine.

8. The mobile vending machine according to claim 1, further comprising a cover including at least a dispensing slot therein.

9. The mobile vending machine according to claim 8, wherein said cover and said body make a relative motion to align an empty receptacle to said dispensing slot in such a way that a content card can be inserted into said empty receptacle.

10. The mobile vending machine according to claim 8, wherein said cover and said body make a relative motion to align an occupied receptacle to said dispensing slot in such a way that a content card can be dispensed from said occupied receptacle.

11. The mobile vending machine according to claim 1, wherein said mobile vending device authenticates a returned content card by checking the data integrity thereof.

12. The mobile vending machine according to claim 1, wherein said content card is a TF card or an SD card.

13. The mobile vending machine according to claim 1, wherein said mobile vending machine is installed in a long-distance travel environment.

14. The mobile vending machine according to claim 1, wherein said long-distance travel environment includes a long-distance transportation and/or its associated stop.

15. A multi-slot content/power pack supporting a mobile vending machine, comprising:
an output interface comprising at least a discharging port;
a battery for charging a mobile device through said discharging port;
at least three expansion slots for holding content cards rented from said mobile vending machine; and
a controller for transferring data from said content cards to said mobile device.

16. The multi-slot content/power pack according to claim 15, wherein said output interface further comprises a data port for transferring said data from said contents to said mobile device.

17. The multi-slot content/power pack according to claim 15, further comprising a wireless communication unit for transferring said data from said contents to said mobile device, wherein said battery provides power to said expansion slots and said wireless communication unit.

18. The multi-slot content/power pack according to claim 15, wherein said content card is a TF card or an SD card.

19. A multi-slot mobile device supporting a mobile vending machine, comprising:
at least three expansion slots for holding content cards rented from said mobile vending machine;
a display to play back the contents from said content cards; and
a battery for providing power to said display and said expansion slots.

20. The multi-slot mobile device according to claim 19, wherein said content card is a TF card or an SD card.
